(19) United States
(12) Patent Application Publication
(10) Pub. No.: US 2025/0289425 A1
(43) Pub. Date: Sep. 18, 2025

(54) APPARATUS AND METHOD FOR CONTROLLING VEHICLE-TO-VEHICLE DISTANCE OF HOST VEHICLE

(71) Applicant: HL Klemove Corp., Incheon (KR)

(72) Inventor: Byung-Joon PARK, Incheon (KR)

(21) Appl. No.: 19/048,447

(22) Filed: Feb. 7, 2025

(30) Foreign Application Priority Data
Mar. 13, 2024 (KR) 10-2024-0034989

(51) Int. Cl. B60W 30/14; B60W 30/16; B60W 30/18; B60W 30/182

(52) U.S. Cl. CPC B60W 30/143; B60W 30/16; B60W 30/18163; B60W 30/182; B60W 2420/403; B60W 2420/408; B60W 2420/54; B60W 2520/10; B60W 2540/18; B60W 2554/802; B60W 2556/35

(57) ABSTRACT

The present disclosure provides an apparatus for controlling vehicle-to-vehicle distance of a host vehicle, the apparatus including a first sensor configured to detect surroundings of a host vehicle; a second sensor configured to detect a steering angle of the host vehicle; a third sensor configured to detect a speed of the host vehicle; and a controller that is communicatively connected to the first sensor, the second sensor, and the third sensor, and is configured to control the host vehicle to drive at a set distance from a preceding vehicle driving in front of the host vehicle, wherein the controller is configured to control the acceleration of the host vehicle when the host vehicle is in the process of changing from a first lane to a second lane next to the first lane.

### CROSS-REFERENCE TO RELATED APPLICATION

This application claims priority to and the benefit from Korean Patent Application No. 10-2024-0034989, filed on Mar. 13, 2024, the disclosures of which is incorporated herein by reference in its entirety.

### BACKGROUND

The present disclosure relates to an apparatus and method for controlling vehicle-to-vehicle distance of a host vehicle.

In general, vehicle-to-vehicle distance control technology refers to a technology that automatically controls a power apparatus and braking apparatus of a control vehicle to maintain a safe distance from a preceding vehicle by measuring the distance between the control vehicle, i.e., the vehicle equipped with an apparatus for controlling distance between vehicles and the preceding vehicle.

In other words, vehicle-to-vehicle distance control technology is a technology that secures a safe distance from the preceding vehicle by reducing the speed of the control vehicle through the control of the power apparatus and the braking apparatus when the distance between the control vehicle and the preceding vehicle is reduced to within a preset safe distance.

Normally, a control vehicle equipped with an apparatus for controlling vehicle-to-vehicle distance travels at a constant speed set by the driver if there is no preceding vehicle, but if there is a preceding vehicle, the vehicle speed is maintained at the speed of the preceding vehicle while maintaining the distance from the preceding vehicle, and if the preceding vehicle disappears, the vehicle speed is accelerated to a set speed again and then driven at a constant speed.

This vehicle-to-vehicle distance control technology controls the vehicle at the set speed without any additional manipulation when the driver sets the speed, thereby capable of improving driving convenience, such as reducing the operation of the accelerator pedal on highways or motorways with low vehicle traffic and reducing driver fatigue when driving long distances.

As for the above vehicle-to-vehicle distance control technology, a technology using radar and lidar sensors or the like is applied to acquire information on the presence or absence of a preceding vehicle, the distance (relative distance) between the control vehicle and the preceding vehicle, and the relative speed.

In the conventional vehicle-to-vehicle distance control technology, if the left lane or right lane is empty based on the vehicle's driving lane in a congested or junction situation on the highway or national road during the vehicle-to-vehicle distance control operation, the steering fluctuates as the control vehicle quickly accelerates to a set speed by changing it to an empty lane, and there is a risk of colliding with an object located next to the changed lane (e.g., a vehicle that is driving or stopping, a guard rail, etc.), and there was a problem of lowering the driver's sense of control due to the rapid increase in speed.

### SUMMARY

In order to solve the above-mentioned problems, the present disclosure is directed to providing an apparatus and method for controlling vehicle-to-vehicle distance capable of preventing a steering from fluctuating by limiting the acceleration of a vehicle when a lane is changed during vehicle-to-vehicle distance control.

In addition, the present disclosure is also directed to providing an apparatus and method for controlling vehicle-to-vehicle distance capable of preventing a collision with a guard rail located next to a changed lane or a stopped or driving vehicle located on a next lane after a lane change.

The problems of the present disclosure are not limited to those mentioned above, and other problems not mentioned will be clearly understood by those of ordinary skill in the art from the following description.

In order to solve the above-mentioned problems, the present disclosure provides an apparatus for controlling vehicle-to-vehicle distance of a host vehicle, the apparatus including a first sensor configured to detect surroundings of a host vehicle; a second sensor configured to detect a steering angle of the host vehicle; a third sensor configured to detect a speed of the host vehicle; and a controller that is communicatively connected to the first sensor, the second sensor, and the third sensor, and is configured to control the host vehicle to drive at a set distance from a preceding vehicle driving in front of the host vehicle, wherein the controller is configured to control the acceleration of the host vehicle based on the fact that the host vehicle is in the process of changing from a first lane to a second lane next to the first lane.

Here, the controller may control the host vehicle so that the host vehicle drives at a first set speed or less.

In addition, the controller may limit the acceleration of the host vehicle based on the fact that the speed of the host vehicle is less than or equal to a second set speed less the first set speed, that there is an object on one side of the second lane, and that there is no object within the set distance in front of the host vehicle on the second lane.

In addition, the controller may increase the host vehicle to the first set speed by controlling the host vehicle at a set acceleration based on that the speed of the host vehicle is less than or equal to a second set speed, that there is no object on one side of the second lane, and that there is no object within the set distance in front of the host vehicle on the second lane.

In addition, the controller may limit the acceleration of the host vehicle based on the fact that the speed of the host vehicle is less than or equal to a second set speed less than the first set speed, that there is no object on one side of the second lane, that there is no object within the set distance in front of the host vehicle on the second lane, and that the speed of another vehicle on the first lane is less than or equal to the second set speed.

In addition, the controller may determine whether the speed of the host vehicle is less than or equal to the second set speed before changing to the second lane.

In addition, the controller may determine whether there is an object on one side of the second lane based on the surroundings of the host vehicle detected by the first sensor.

In addition, the controller may determine whether the host vehicle is in the process of changing from the first lane to the second lane based on the steering angle of the host vehicle detected by the second sensor.

In addition, the controller may determine whether there is an object on the second lane based on the surroundings of the host vehicle detected by the first sensor.

In addition, the controller may increase the speed of the host vehicle to a first set speed based on the fact that there is no object within the set distance in front of the host vehicle.

In addition, the controller may determine that the host vehicle is in the process of changing from the first lane to the second lane based on the fact that the steering angle of the host vehicle is changed to a set angle.

In addition, the controller may determine whether the host vehicle operates in a vehicle-to-vehicle distance control mode within a set time based on the fact that the host vehicle changes from the first lane to the second lane.

In addition, the controller may control the acceleration of the host vehicle based on the operation of the host vehicle in the vehicle-to-vehicle distance control mode.

In addition, the present disclosure provides a method for controlling vehicle-to-vehicle distance of a host vehicle, the method including detecting surroundings, steering angle, and speed of a host vehicle; controlling the host vehicle to drive at a set distance from a preceding vehicle driving in front of the host vehicle; determining whether the host vehicle is in the process of changing from the first lane to a second lane next to the first lane based on the surroundings, the steering angle, and the speed of the host vehicle; and controlling the acceleration of the host vehicle based on the fact that the host vehicle is in the process of changing from the first lane to the second.

Here, the controlling the acceleration of the host vehicle may include limiting the acceleration of the host vehicle based on the fact that there is an object on one side of the second lane, and that there is no object within the set distance in front of the host vehicle on the second lane.

In addition, the controlling the acceleration of the host vehicle may include increasing the host vehicle to a first set speed by controlling the host vehicle at a set acceleration based on the fact that there is no object on one side of the second lane, and that there is no object within the set distance in front of the host vehicle on the second lane.

In addition, the controlling the acceleration of the host vehicle may include limiting the acceleration of the host vehicle based on the fact that the speed of the host vehicle is less than or equal to a second set speed less than the first set speed, that there is no object on one side of the second lane, that there is no object within the set distance in front of the host vehicle on the second lane, and that the speed of another vehicle on the first lane is less than or equal to the second set speed.

In addition, the controlling the acceleration of the host vehicle may include determining whether the speed of the host vehicle is less than or equal to a second set speed, and determining whether there is an object on one side of the second lane based on the surroundings of the host vehicle.

In addition, the controlling the acceleration of the host vehicle may include determining whether the host vehicle is in the process of changing from the first lane to the second lane based on the steering angle of the host vehicle, and determining whether there is an object on the second lane based on the surroundings of the host vehicle.

In addition, the controlling the acceleration of the host vehicle may include increasing the speed of the host vehicle to a first set speed based on the fact that there is no object within the set distance in front of the host vehicle on the second lane.

In addition, the controlling the acceleration of the host vehicle may include determining that the host vehicle is in the process of changing from the first lane to the second lane based on the fact that the steering angle of the host vehicle is changed to a set angle.

In addition, the controlling the acceleration of the host vehicle may include determining whether the host vehicle operates in a vehicle-to-vehicle distance control mode within a set time based on the fact that the host vehicle changes from the first lane to the second lane; and controlling the acceleration of the host vehicle based on the fact that the host vehicle operates in the vehicle-to-vehicle distance control mode.

According to the present disclosure, it is possible to prevent a steering from fluctuating by limiting the acceleration of a vehicle when a lane is changed during vehicle-to-vehicle distance control.

In addition, according to the present disclosure, it is possible to prevent a collision with a guard rail located next to a changed lane or a stopped or driving vehicle located on a next lane after a lane change.

Advantageous effects of the present disclosure are not limited to the above-described effects, and should be understood to include all effects that can be inferred from the configuration of the disclosure described in the detailed description or claims of the present disclosure.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIGS. 1A and 1B are diagrams for describing an operation of a general apparatus for controlling vehicle-to-vehicle distance;

FIG. 2 is a block diagram of an apparatus for controlling vehicle-to-vehicle distance according to an exemplary embodiment of the present disclosure;

FIGS. 3A, 3B, 4, 5A, and 5B are diagrams illustrating that a vehicle-to-vehicle distance control technology is applied in a lane change process according to an exemplary embodiment of the present disclosure;

FIG. 6 is a flowchart of a method for controlling vehicle-to-vehicle distance according to an exemplary embodiment of the present disclosure; and

FIG. 7 is a flowchart of a method for controlling acceleration of a host vehicle during vehicle-to-vehicle distance control according to an exemplary embodiment of the present disclosure.

### DETAILED DESCRIPTION

Hereinafter, embodiments of the present disclosure will be described in detail so that those skilled in the art to which the present disclosure pertains can easily carry out the embodiments. The present disclosure may be implemented in many different forms and is not limited to the embodiments described herein. In order to clearly describe the present disclosure, portions not related to the description are omitted from the accompanying drawings, and the same or similar components are denoted by the same reference numerals throughout the specification.

The words and terms used in the specification and the claims are not limitedly construed as their ordinary or dictionary meanings, and should be construed as meaning and concept consistent with the technical spirit of the present disclosure in accordance with the principle that the inventors can define terms and concepts in order to best describe their disclosure.

In the specification, it should be understood that the terms such as “comprise” or “have” are intended to specify the presence of features, numbers, steps, operations, components, parts, or combinations thereof described in the specification and do not preclude the possibility of the presence or addition of one or more other features, numbers, steps, operations, components, parts, or combinations thereof.

The present disclosure relates to an apparatus and method for controlling vehicle-to-vehicle distance, capable of preventing colliding with an object located next to the changed lane (e.g., a vehicle that is driving or stopping, a guard rail, etc.) when the steering fluctuates as the host vehicle quickly accelerates to a set speed by changing it to an empty lane if the left lane or right lane is empty based on the host vehicle's driving lane in a congested or junction situation on the highway or national road during the vehicle-to-vehicle distance control operation of the host vehicle.

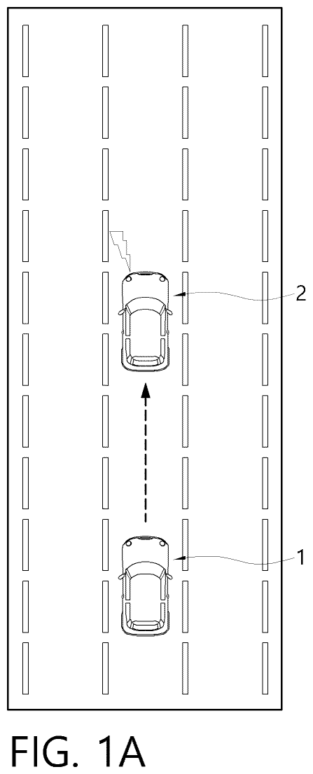

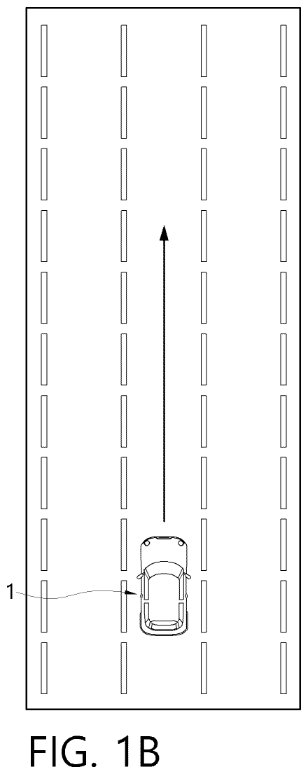

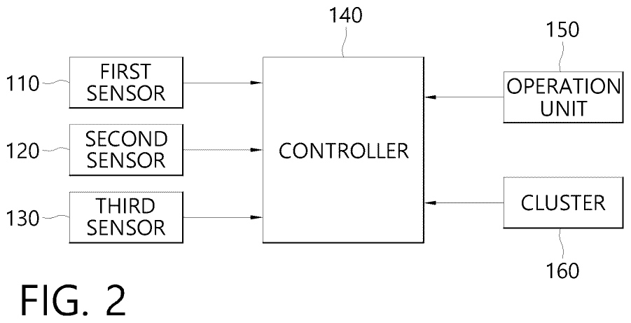

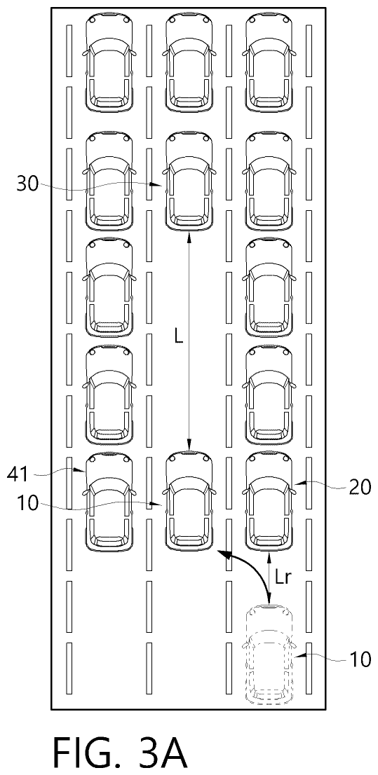

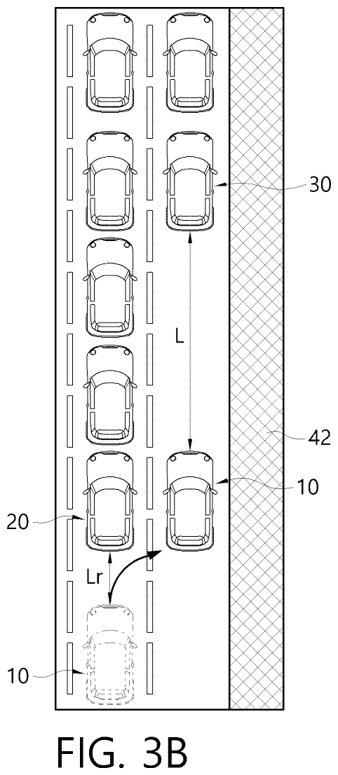

FIGS. 1A and 1B are diagrams for describing an operation of a general apparatus for controlling vehicle-to-vehicle distance; FIG. 2 is a block diagram of an apparatus for controlling vehicle-to-vehicle distance according to an exemplary embodiment of the present disclosure; and FIGS. 3A, 3B, 4, 5A, and 5B are diagrams illustrating that a vehicle-to-vehicle distance control technology is applied in a lane change process according to an exemplary embodiment of the present disclosure.

Referring to FIGS. 1A and 1i, a general apparatus for controlling vehicle-to-vehicle distance receives sensing data from a sensor (e.g., radar and lidar) mounted on a host vehicle 1 to perform smart cruise control (SSC), acquires information such as the presence or absence of a preceding vehicle 2 traveling on the same lane as the host vehicle 1, and the relative distance, the relative speed, and the relative deceleration between the host vehicle 1 and the preceding vehicle 2, and uses the acquired information to perform cooperative control with a brake control apparatus and engine control apparatus, thereby performing control of a braking apparatus and an engine.

When controlling vehicle-to-vehicle distance, the brake control apparatus controls the braking force of the host vehicle 1 through hydraulic control of the braking apparatus while calculating and distributing the braking torque required for braking, and the engine control apparatus controls engine torque.

Accordingly, if there is no preceding vehicle 2 during vehicle-to-vehicle distance control, constant speed driving is performed at the set speed (SetSpd) set by the driver (FIG. 1), and if there is a preceding vehicle 2, vehicle driving is performed according to the speed (Vehspd) of the preceding vehicle 2 while maintaining the set distance from the preceding vehicle 2 (FIG. 1A), and if the preceding vehicle 2 disappears, constant speed driving is performed after acceleration to the set speed (SetSpd) again (FIG. 1).

Hereinafter, an apparatus for controlling vehicle-to-vehicle distance according to an exemplary embodiment of the present disclosure will be described in detail with reference to FIGS. 2, 3A, and 3B.

The apparatus for controlling vehicle-to-vehicle distance according to an exemplary embodiment of the present disclosure is an apparatus for performing smart cruise control (SSC), and may include a first sensor 110, a second sensor 120, a third sensor 130, a controller 140, an operation unit 150, and a cluster 160.

The first sensor 110 may detect the surroundings of the host vehicle 10, for example, another vehicle that is driving or stopped, a guard rail, and the like. Here, a plurality of first sensors 110 may be mounted to the host vehicle 10 to detect the front, rear, and left and right sides of the host vehicle 10, and may be a radar, a lidar, a camera, and an ultrasonic sensor, but are not limited thereto.

The second sensor 120 may detect a steering angle of the host vehicle 10 that is changed according to a driver's manipulation of the steering wheel. Here, the second sensor 120 may be a steering angle sensor.

The third sensor 130 may detect the speed of the host vehicle 10. Here, the third sensor 130 may be a speed sensor.

The driver of the host vehicle 10 performs on/off operation of a vehicle-to-vehicle distance control mode, speed setting, vehicle-to-vehicle distance setting, and the like through the operation unit 150 (e.g., operation button, etc.). In addition, the controller 140 performs normal vehicle-to-vehicle distance control based on information collected from the first sensor 110, the second sensor 120, and the third sensor 130 after setting the vehicle-to-vehicle distance control mode On, speed, and vehicle-to-vehicle distance.

Here, when the driver of the host vehicle 10 sets the speed and the vehicle-to-vehicle distance by operating the operation unit 150, the set speed and the set distance information may be displayed through the cluster 160.

The controller 140 is communicatively connected to the first sensor 110, the second sensor 120, and the third sensor 130, and may control the host vehicle 10 to drive at a set distance Lr from the preceding vehicle 20 driving in front of the host vehicle 10. Here, the set distance Lr may be a distance set by the driver of the host vehicle through the operation unit 150.

The controller 140 may control the host vehicle 10 to drive at a first set speed (e.g., 80 km/s) or less. That is, when there is no preceding vehicle within the set distance, the controller 140 may control the host vehicle 10 to drive up to the first set speed. Here, the first set speed may be a speed set by the driver of the host vehicle 10 through the operation unit 150.

In particular, the present disclosure is characterized in that the controller 140 controls the acceleration of the host vehicle 10 based on the progress of changing the host vehicle 10 from the first lane to the second lane next to the first lane.

Specifically, the controller 140 may determine whether the speed of the host vehicle 10 before changing the host vehicle 10 from the first lane to the second lane is less than or equal to a second set speed (e.g., 40 km/h). Here, the fact that the speed of the host vehicle 10 is less than or equal to the second set speed may mean that the first lane on which the host vehicle 10 is driving is in a congested state or a junction joining state.

In this case, when the host vehicle 10 is in the vehicle-to-vehicle distance control mode, the host vehicle 10 may drive according to the speed of the preceding vehicle 20 at a set distance Lr from the preceding vehicle 20.

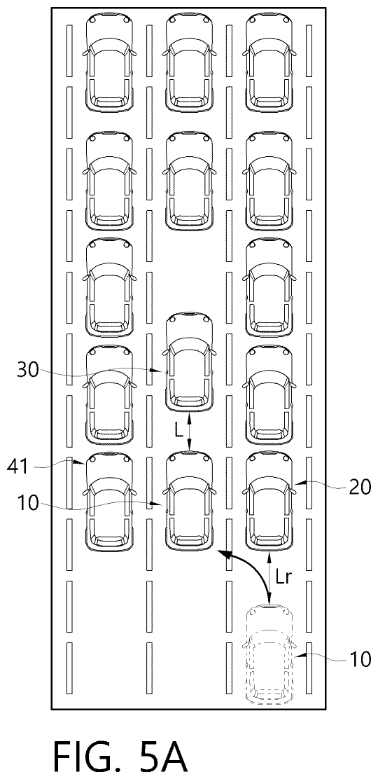

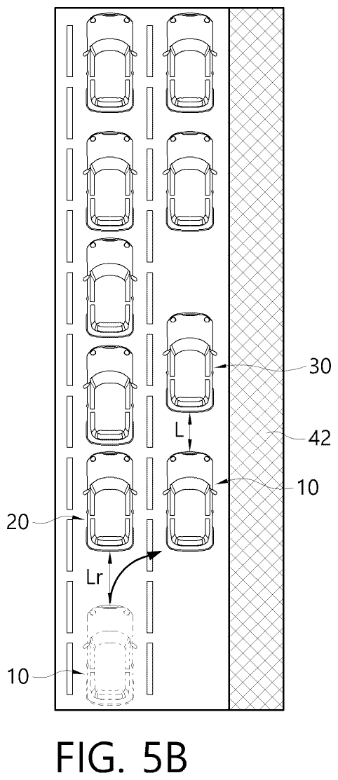

The controller 140 may determine whether there is an object on one side of the second lane to be changed based on the surroundings of the host vehicle 10 detected by the first sensor 110. Here, the object may be another vehicle 41 stopped or driving on the third lane next to the second lane, as shown in FIG. 3A and FIG. 5A, or a guard rail 42 next to the second lane, as shown in FIG. 3B and FIG. 5B.

The controller 140 may determine whether the host vehicle 10 is in the process of changing from the first lane to the second lane based on the steering angle of the host vehicle 10 detected by the second sensor 120. Specifically, the controller 140 may determine that the host vehicle 10 is in the process of changing from the first lane to the second lane based on the change in the steering angle of the host vehicle 10 to a set angle.

The controller 140 may determine whether there is an object on the second lane based on the surroundings of the host vehicle 10 detected by the first sensor 110. Here, the object may be another vehicle 30 stopped or driving on the second lane.

The controller 140 may increase the speed of the host vehicle 140 to a set speed based on the fact that there is no object within a set distance Lr in front of the host vehicle 10.

The controller 140 may determine whether the host vehicle 10 operates in the vehicle-to-vehicle distance control mode within a set time based on the change of the host vehicle 10 from the first lane to the second lane.

Here, the controller 140 may control the acceleration of the host vehicle 10 based on the operation of the host vehicle 10 in the vehicle-to-vehicle distance control mode.

However, if the vehicle-to-vehicle distance control mode is already in operation, the process of checking the vehicle-to-vehicle distance control mode is omitted, and the controller may directly control the acceleration of the host vehicle 10 based on the change of the host vehicle 10 from the first lane to the second lane.

As shown in FIGS. 3A and 3B, the controller 140 may limit the acceleration of the host vehicle 10 based on the fact that the speed of the host vehicle 10 on the first lane is less than or equal to the second set speed less than the first set speed, that there are objects 41 and 42 on one side of the second lane, that the host vehicle 10 is changing from the first lane to the second lane, and that there is no object within a set distance Lr in front of the host vehicle 10.

In other words, as shown in FIG. 3A, since there is a third lane on the left side of the second lane to which the host vehicle 10 intends to change, there is another vehicle 41 on the third lane, the host vehicle 10 is changing from the first lane to the second lane, and yet another vehicle 30 in front of the host vehicle 10 is separated by a distance L more than or equal to a set distance Lr after the lane change, the controller 140 in this case may limit the acceleration of the host vehicle 10 to prevent the steering from fluctuating due to sudden acceleration and to prevent a collision with another vehicle 41 on the third lane.

In addition, as shown in FIG. 3B, since there is a guard rail 42 on the right side of the second lane to which the host vehicle 10 intends to change, the host vehicle 10 is changing from the first lane to the second lane, and another vehicle 30 in front of the host vehicle 10 is separated by a distance L more than or equal to a set distance Lr after the lane change, the controller 140 in this case may limit the acceleration of the host vehicle 10 to prevent the steering from fluctuating due to sudden acceleration and to prevent a collision with the guard rail 42 on the right side of the second lane.

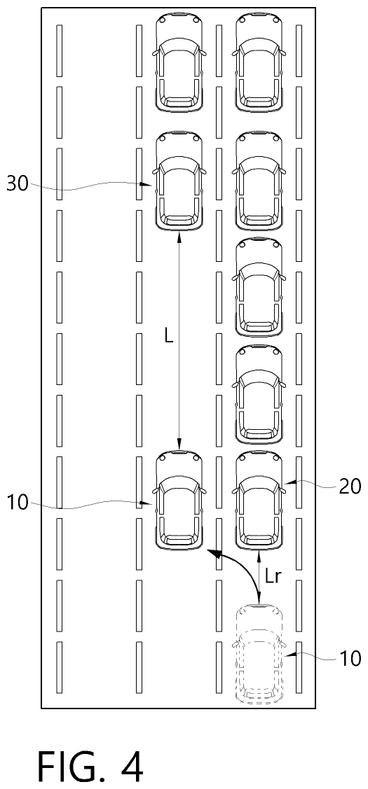

As shown in FIG. 4, the controller 140 may control the host vehicle 10 to increase the first set speed by controlling the host vehicle 10 at a set acceleration based on the fact that the speed of the host vehicle 10 is less than or equal to the second set speed less than the first set speed, that there is no object on one side of the second lane, and that there is no object 30 within a set distance Lr in front of the host vehicle 10 after the host vehicle 10 changes to the second lane. In other words, in this case, even if the host vehicle 10 accelerates rapidly, there is no risk of collision with other vehicles even if the steering fluctuates due to sudden acceleration, since there is no other vehicle stopping or driving on the third lane next to the second lane.

In contrast, the controller 140 may limit the acceleration of the host vehicle 10 based on the fact that the speed of the host vehicle 10 on the first lane is less than or equal to the second set speed less than the first set speed, that there is no object on one side of the second lane, that the host vehicle 10 is changing from the first lane to the second lane, that there is no object within a set distance Lr in front of the host vehicle 10, and that the speed of yet another vehicle 20 on the first lane is less than or equal to the second set speed.

In other words, as shown in FIG. 4, when the other vehicle 20 on the first lane is below the second set speed even though there is no object on the third lane, the situation of the first lane can be judged as a congestion situation or a junction joining situation. In this case, by limiting the acceleration of the host vehicle 10, it is possible to prevent the steering from fluctuating due to sudden acceleration and to prevent a collision with another vehicle 20 on the first lane.

Here, the speed of the other vehicle 20 on the first lane may be measured by at least one of a radar, a lidar, and an ultrasonic sensor included in the first sensor 110 provided in the host vehicle 10.

As shown in FIGS. 5A and 5B, the controller 140 does not limit the acceleration of the host vehicle 10 based on the fact that the speed of the host vehicle 10 is less than or equal to the second set speed less than the first set speed, that there is an object on one side of the second lane, and that there is an object 30 within a set distance Lr in front of the host vehicle 10 after the host vehicle 10 changes to the second lane. In this case, there is an object, that is, the preceding vehicle 30, within a set distance Lr in front of the host vehicle 10 on the second lane, so that the host vehicle 10 is controlled to drive at a set distance from the preceding vehicle 30, so there is no fear of rapid acceleration, so the acceleration is not limited.

In other words, as shown in FIG. 5A, since there is a third lane on the left side of the second lane to which the host vehicle 10 intends to change, there is another vehicle 41 on the third lane, the host vehicle 10 is changing from the first lane to the second lane, and yet another vehicle 30 in front of the host vehicle 10 is separated by a distance L less than a set distance Lr after the host vehicle 10 changes to the second lane, the controller 140 in this case does not limit the acceleration of the host vehicle 10.

In addition, as shown in FIG. 5B, since there is a guard rail 42 on the right side of the second lane to which the host vehicle 10 intends to change, the host vehicle 10 is changing from the first lane to the second lane, and another vehicle 30 in front of the host vehicle 10 is separated by a distance L less than a set distance Lr, the controller 140 in this case does not limit the acceleration of the host vehicle 10.

According to the apparatus for controlling vehicle-to-vehicle distance of the present disclosure, if the left lane or right lane is empty based on the host vehicle's driving lane in a congested or junction situation on the highway or national road during the vehicle-to-vehicle distance control operation of the host vehicle, it is possible to prevent colliding with an object located next to the changed lane (e.g., a vehicle that is driving or stopping, a guard rail, etc.) when the steering fluctuates as the host vehicle quickly accelerates to a set speed by changing it to an empty lane.

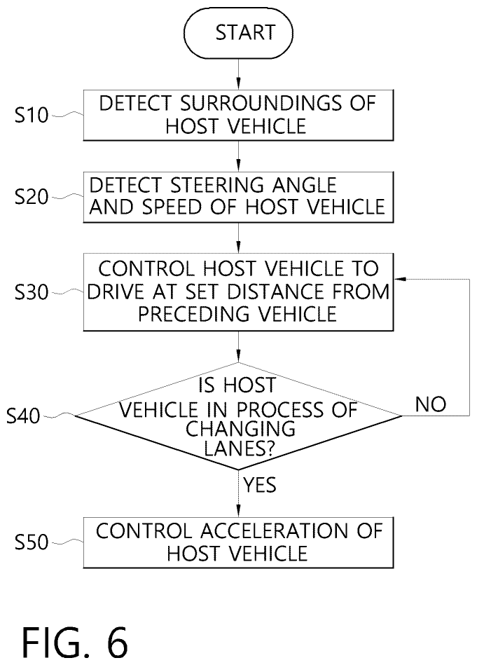

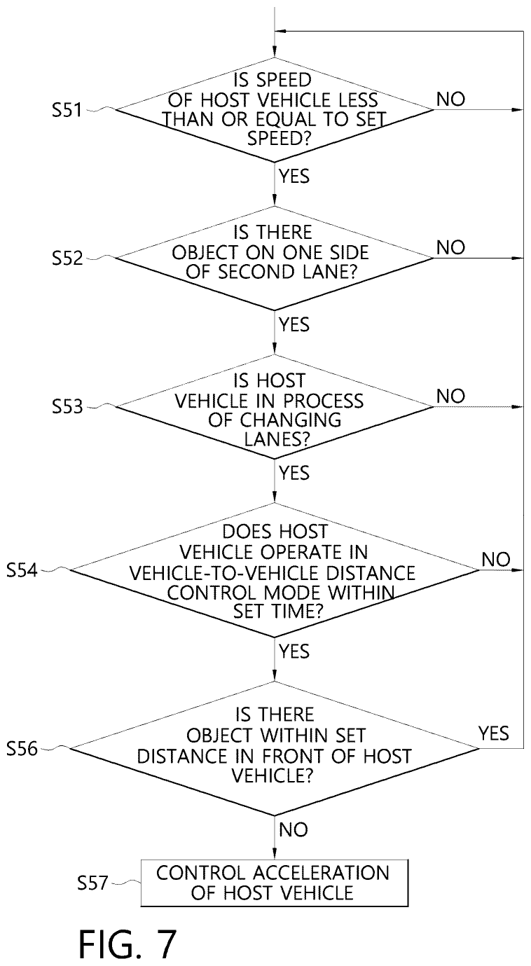

FIG. 6 is a flowchart of a method for controlling vehicle-to-vehicle distance according to an exemplary embodiment of the present disclosure; and FIG. 7 is a flowchart of a method for controlling acceleration of a host vehicle during vehicle-to-vehicle distance control according to an exemplary embodiment of the present disclosure.

Hereinafter, an apparatus for controlling vehicle-to-vehicle distance according to an exemplary embodiment of the present disclosure will be described in detail with reference to FIGS. 6 and 7.

First, referring to FIG. 6, the first sensor 110 detects the surroundings of the host vehicle 10, e.g., other vehicles that are driving or stopped, a guard rail, etc. located in front, rear, and left and right sides of the host vehicle 10 in step S10.

Next, the second sensor 120 detects the steering angle of the host vehicle 10 that is changed according to the driver's manipulation of the steering wheel, and the third sensor 130 detects the speed of the host vehicle 10 in step S20.

Next, the controller 140 that is communicatively connected to the first sensor 110, the second sensor 120, and the third sensor 130 controls the host vehicle 10 to drive at a set distance Lr from a preceding vehicle 20 driving in front of the host vehicle 10 in step S30.

Next, the controller 140 controls the host vehicle 10 to drive at a first set speed (e.g., 80 km/s) or less in step S30. That is, when there is no preceding vehicle within the set distance, the controller 140 controls the host vehicle 10 to drive up to the first set speed.

Next, the controller 140 determines whether the host vehicle 10 is in the process of changing lanes in step S40.

Here, the controller controls the acceleration of the host vehicle 10 based on the fact that the host vehicle 10 is in the process of changing from the first lane to the second lane next to the first lane in step S50, and controls the host vehicle 10 to drive at a set distance from the preceding vehicle based on the fact that the host vehicle 10 is not in the progress of changing from the first lane to the second lane in step S30.

Referring to FIG. 7, a method of controlling acceleration of the host vehicle during vehicle-to-vehicle distance control according to an exemplary embodiment of the present disclosure will be described in detail, and first, the controller 140 determines whether the speed of the host vehicle 10 before the host vehicle 10 changes to the second lane is less than or equal to a second set speed (e.g., 40 km/h) in step S51. Here, the fact that the speed of the host vehicle 10 is less than or equal to the second set speed may mean that the first lane on which the host vehicle 10 is driving is in a congested state or a junction joining state.

In this case, when the host vehicle 10 is in the vehicle-to-vehicle distance control mode, the host vehicle 10 drives according to the speed of the preceding vehicle 20 at a set distance Lr from the preceding vehicle 20.

Next, the controller 140 determines whether there is an object on one side of the second lane to be changed based on the surroundings of the host vehicle 10 detected by the first sensor 110 in step S52. Here, the object may be another vehicle 41 stopped or driving on the third lane next to the second lane or a guard rail 42 next to the second lane.

Next, the controller 140 determines whether the host vehicle 10 is in the process of changing from the first lane to the second lane based on the steering angle of the host vehicle 10 detected by the second sensor 120 in step S53. Specifically, the controller determines that the host vehicle 10 is in the process of changing from the first lane to the second lane based on the change in the steering angle of the host vehicle 10 to a set angle.

Next, the controller 140 determines whether the host vehicle 10 operates in the vehicle-to-vehicle distance control mode within a set time based on the change of the host vehicle 10 from the first lane to the second lane in step S54.

In this case, the controller 140 controls the acceleration of the host vehicle 10 based on the operation of the host vehicle 10 in the vehicle-to-vehicle distance control mode.

However, if the vehicle-to-vehicle distance control mode is already in operation, the process of checking the vehicle-to-vehicle distance control mode is omitted, and the controller directly controls the acceleration of the host vehicle 10 based on the change of the host vehicle 10 from the first lane to the second lane.

Next, the controller 140 determines whether there is an object on the second lane based on the surroundings of the host vehicle 10 detected by the first sensor 110 in step S56. Here, the object may be another vehicle 30 stopped or driving on the second lane.

Next, the controller 140 limits the acceleration of the host vehicle 10 based on the fact that there is no object within a set distance Lr in front of the host vehicle 10 in step S57.

In other words, since there is a third lane on the left side of the second lane to which the host vehicle 10 intends to change, there is another vehicle 41 on the third lane, the host vehicle 10 is changing from the first lane to the second lane, and another vehicle 30 in front of the host vehicle 10 is separated by a distance L more than or equal to a set distance Lr after the host vehicle 10 changes to the second lane, the controller in this case may limit the acceleration of the host vehicle 10 to prevent the steering from fluctuating due to sudden acceleration and to prevent a collision with another vehicle 41 on the third lane.

In addition, since there is a guard rail 42 on the right side of the second lane to which the host vehicle 10 intends to change, the host vehicle 10 is changing from the first lane to the second lane, and another vehicle 30 in front of the host vehicle 10 is separated by a distance L more than or equal to a set distance Lr after the host vehicle 10 changes to the second lane, the controller 140 in this case may limit the acceleration of the host vehicle 10 to prevent the steering from fluctuating due to sudden acceleration and to prevent a collision with the guard rail 42 on the right side of the second lane.

In contrast, the controller controls the host vehicle 10 to increase the first set speed by controlling the host vehicle 10 at a set acceleration based on the fact that the speed of the host vehicle 10 is less than or equal to the second set speed less than the first set speed, that there is no object on one side of the second lane, and that there is no object 30 within a set distance Lr in front of the host vehicle 10 after the host vehicle 10 changes to the second lane. In other words, in this case, even if the host vehicle 10 accelerates rapidly, there is no risk of collision with other vehicles even if the steering fluctuates due to sudden acceleration, since there is no other vehicle stopping or driving on the third lane next to the second lane.

In addition, the controller does not limit the acceleration of the host vehicle 10 based on the fact that the speed of the host vehicle 10 is less than or equal to the second set speed less than the first set speed, that there is an object on one side of the second lane, and that there is an object 30 within a set distance Lr in front of the host vehicle 10 after the host vehicle 10 changes to the second lane. In this case, there is an object, that is, the preceding vehicle 30, within a set distance Lr in front of the host vehicle 10 on the second lane, so that the host vehicle 10 is controlled to drive at a set distance from the preceding vehicle 30, so there is no fear of rapid acceleration, so the acceleration is not limited.

In other words, since there is a third lane on the left side of the second lane to which the host vehicle 10 intends to change, there is another vehicle 41 on the third lane, the host vehicle 10 is changing from the first lane to the second lane, and yet another vehicle 30 in front of the host vehicle 10 is separated by a distance L less than a set distance Lr after the host vehicle 10 changes to the second lane, the controller in this case does not limit the acceleration of the host vehicle 10.

In addition, since there is a guard rail 42 on the right side of the second lane to which the host vehicle 10 intends to change, the host vehicle 10 is changing from the first lane to the second lane, and another vehicle 30 in front of the host vehicle 10 is separated by a distance L less than a set distance Lr after the host vehicle 10 changes from the first lane to the second lane, the controller in this case does not limit the acceleration of the host vehicle 10.

According to the method for controlling vehicle-to-vehicle distance of the present disclosure, if the left lane or right lane is empty based on the host vehicle's driving lane in a congested or junction situation on the highway or national road during the vehicle-to-vehicle distance control operation of the host vehicle, it is possible to prevent colliding with an object located next to the changed lane (e.g., a vehicle that is driving or stopping, a guard rail, etc.) when the steering fluctuates as the host vehicle quickly accelerates to a set speed by changing it to an empty lane.

It should be understood that the effects of the present disclosure are not limited to the above-described effects, and include all effects inferable from a configuration of the disclosure described in detailed descriptions or claims of the present disclosure.

Although embodiments of the present disclosure have been described, the spirit of the present disclosure is not limited by the embodiments presented in the specification. Those skilled in the art who understand the spirit of the present disclosure will be able to easily suggest other embodiments by adding, changing, deleting, or adding components within the scope of the same spirit, but this will also be included within the scope of the spirit of the present disclosure.

What is claimed is:

1. An apparatus for controlling vehicle-to-vehicle distance of a host vehicle, the apparatus comprising:
a first sensor configured to detect surroundings of the host vehicle;
a second sensor configured to detect a steering angle of the host vehicle;
a third sensor configured to detect a speed of the host vehicle; and
a controller configured to connect the first sensor, the second sensor, and the third sensor, and is configured to control the host vehicle to drive at a set distance from a preceding vehicle driving in front of the host vehicle,
the controller is configured to:
control the acceleration of the host vehicle when the host vehicle is in the process of changing from a first lane to a second lane next to the first lane.

2. The apparatus of claim 1, wherein the controller is configured to:
control the host vehicle so that the host vehicle drives at a first set speed or less.

3. The apparatus of claim 2, wherein the controller is configured to:
limit the acceleration of the host vehicle when the speed of the host vehicle is less than or equal to a second set speed less than the first set speed, there is an object on one side of the second lane, and there is no object within the set distance in front of the host vehicle on the second lane.

4. The apparatus of claim 2, wherein the controller is configured to:
increase the host vehicle to the first set speed by controlling the host vehicle at a set acceleration when the speed of the host vehicle is less than or equal to a second set speed, there is no object on one side of the second lane, and there is no object within the set distance in front of the host vehicle on the second lane.

5. The apparatus of claim 2, wherein the controller is configured to:
limit the acceleration of the host vehicle when the speed of the host vehicle is less than or equal to a second set speed less than the first set speed, there is no object on one side of the second lane, there is no object within the set distance in front of the host vehicle on the second lane, and the speed of another vehicle on the first lane is less than or equal to the second set speed.

6. The apparatus of claim 3, wherein the controller is configured to:
determine whether the speed of the host vehicle is less than or equal to the second set speed before changing to the second lane.

7. The apparatus of claim 3, wherein the controller is configured to:
determine whether there is an object on one side of the second lane based on the surroundings of the host vehicle detected by the first sensor.

8. The apparatus of claim 3, wherein the controller is configured to:
determine whether the host vehicle is in the process of changing from the first lane to the second lane based on the steering angle of the host vehicle detected by the second sensor.

9. The apparatus of claim 3, wherein the controller is configured to:
determine whether there is an object on the second lane based on the surroundings of the host vehicle detected by the first sensor.

10. The apparatus of claim 3, wherein the controller is configured to:
determine that the host vehicle is in the process of changing from the first lane to the second lane when the steering angle of the host vehicle is changed to a set angle.

11. The apparatus of claim 3, wherein the controller is configured to:
determine whether the host vehicle operates in a vehicle-to-vehicle distance control mode within a set time when the host vehicle changes from the first lane to the second lane.

12. The apparatus of claim 11, wherein the controller is configured to:
control the acceleration of the host vehicle when the host vehicle operates in the vehicle-to-vehicle distance control mode.

13. A method for controlling vehicle-to-vehicle distance of a host vehicle, the method comprising:
detecting surroundings, steering angle, and speed of the host vehicle;
controlling the host vehicle to drive at a set distance from a preceding vehicle driving in front of the host vehicle;
determining whether the host vehicle is in the process of changing from the first lane to a second lane next to the first lane based on the surroundings, the steering angle, and the speed of the host vehicle; and
controlling the acceleration of the host vehicle when the host vehicle is in the process of changing from the first lane to the second.

14. The method of claim 13, wherein the controlling the acceleration of the host vehicle comprises:
limiting the acceleration of the host vehicle when there is an object on one side of the second lane and there is no object within the set distance in front of the host vehicle on the second lane.

15. The method of claim 13, wherein the controlling the acceleration of the host vehicle comprises:
increasing the host vehicle to a first set speed by controlling the host vehicle at a set acceleration when there is no object on one side of the second lane and there is no object within the set distance in front of the host vehicle on the second lane.

16. The method of claim 13, wherein the controlling the acceleration of the host vehicle comprises:
limiting the acceleration of the host vehicle when the speed of the host vehicle is less than or equal to a second set speed less than the first set speed, there is no object on one side of the second lane, there is no object within the set distance in front of the host vehicle on the second lane, and the speed of another vehicle on the first lane is less than or equal to the second set speed.

17. The method of claim 14, wherein the controlling the acceleration of the host vehicle further comprises:
determining whether the speed of the host vehicle is less than or equal to a second set speed; and
determining whether there is an object on one side of the second lane based on the surroundings of the host vehicle.

18. The method of claim 14, wherein the controlling the acceleration of the host vehicle further comprises:
determining whether the host vehicle is in the process of changing from the first lane to the second lane based on the steering angle of the host vehicle; and
determining whether there is an object on the second lane based on the surroundings of the host vehicle.

19. The method of claim 14, wherein the controlling the acceleration of the host vehicle further comprises:
increasing the speed of the host vehicle to a first set speed when there is no object within the set distance in front of the host vehicle on the second lane.

20. The method of claim 14, wherein the controlling the acceleration of the host vehicle further comprises:
determining whether the host vehicle operates in a vehicle-to-vehicle distance control mode within a set time when the host vehicle changes from the first lane to the second lane; and
controlling the acceleration of the host vehicle when the host vehicle operates in the vehicle-to-vehicle distance control mode.
